(19) United States
(12) Patent Application Publication
(10) Pub. No.: US 2025/0144913 A1
(43) Pub. Date: May 8, 2025

(54) Side Pressure Plate and its Preparation Method

(71) Applicant: Qidong LI, Xinjiang (CN)

(72) Inventor: Qidong LI, Xinjiang (CN)

(21) Appl. No.: 18/503,162

(22) Filed: Nov. 6, 2023

(51) Int. Cl. B32B 9/04; B27J 1/00; B32B 3/14; B32B 3/18; B32B 7/12; B32B 9/02; B32B 37/12; B32B 38/00

(52) U.S. Cl. CPC B32B 9/04; B27J 1/003; B32B 3/14; B32B 3/18; B32B 7/12; B32B 9/02; B32B 37/12; B32B 38/0004; B32B 2307/7376; B32B 2317/00

(57) ABSTRACT

A side pressure plate and a preparation method, comprising a first layer plate, a second layer plate and a third layer plate, all of which comprise a plurality of square plates, the square plates comprising a cutting surface and a long side surface, the cutting surfaces of the plurality of square plates being bonded to each other to form the second layer plate, and the long side surfaces of the plurality of square plates being bonded to each other to form the first layer plate and the third layer plate, the three layers are bonded and pressed together to form the side pressure plate. Cutting a number of hollow cylindrical bamboo tubes into multiple bamboo strips paste side pressure to form the first layer of plate, the second layer of plate and the third layer of plate, and finally the three layers of plate bonding.

### TECHNICAL FIELD

The present invention relates to the technical field of plates, and in particular relates to a side pressure plate and its preparation method.

### BACKGROUND

Plate in the life of a very wide range of applications, the traditional plate of the upper and lower three layers are hollow cylindrical bamboo tube along one side of the truncation, laying into a rectangular shape, and then pressed together so as to form a plate, made of this method of plate structure is simple, weak pressure load-bearing capacity, in the use of easy to fracture, the use of a short service life.

For example, the moisture-resistant engineered hardwood veneer flooring disclosed in U.S. Pat. No. 11,454,036 has low strength, cannot withstand large weights and pressures, and the boards crack over time, and the same problem occurs with the laminated bamboo deck and concrete composite decking system disclosed in U.S. Patent No. US20190226196A1.

Based on the above problems, it is necessary to put forward a new side pressure plate, with high stability and plate surface flat and not easy to deform, can withstand strong pressure, and the plate surface is not easy to crack, long service life.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

The present invention provides a method of preparing a side pressure plate, the method comprising a plurality of bamboo tubes with a hollow cylindrical shape were collected.

A plurality of bamboo strips are formed by truncating the bamboo tube along a longitudinal plane.

A plurality of the bamboo strips are bonded together in cross section and laid flat on a flat plane to form an approximately rectangular shape as an intermediate plate.

The surfaces of a plurality of the bamboo strips are bonded to each other and laid flat on a flat plane to form a roughly rectangular shape as the upper layer plate and lower layer plate.

Press-fit the upper layer plate and the lower layer plate.

Bonding the upper layer plate to the upper surface of the intermediate plate and bonding the lower layer plate to the lower surface of the intermediate plate.

The upper layer plate, the intermediate plate and the lower layer plate are pressed together to finally form the side pressure plate with a compact structure.

The present invention provides a side pressure plate comprising a first layer plate and a third layer plate, and a second layer plate provided between the first layer plate and the third layer plate.

Wherein the first layer plate, the second layer plate and the third layer plate all comprise a plurality of square plates.

The square plate has at least one cutting surface, and the cutting surface of a plurality of the square plates are bonded to each other to form the second layer plate.

The square plate further comprises at least one long side surface, and the long side surface of a plurality of the square plates are bonded to each other to form the first layer plate and the third layer plate.

The present invention also provides a side pressure plate comprising a first layer plate and a third layer plate, and a second layer plate provided between the first layer plate and the third layer plate.

Wherein the second layer plate comprises a plurality of first strips, the first strips having at least one first cutting surface and at least one first long side surface, the first cutting surface of the plurality of the first strips being bonded to each other to form the second layer plate.

The first layer plate and the third layer plate both comprise a plurality of second strips, the second strips having at least one second cutting surface and at least one second long side surface, the second long side surfaces of the plurality of the second strips being bonded to each other to form the first layer plate and third layer plate.

Wherein the height of the first strips is greater than the height of the second strips.

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is a flow chart of a method of preparing a side pressure plate;

FIG. 2 is a schematic view of the overall structure of the side pressure plate;

FIG. 3 is a schematic view of the exploded structure of the side pressure plate;

FIG. 4 is a schematic view of the cutting surface and the long side surface of the square strip;

FIG. 5 is a schematic view of the length and width of the square strip;

FIG. 6 is a schematic view of the placement of the square strip;

FIG. 7 is a schematic view of the first rounded corner and the second rounded corner of the side pressure plate;

FIG. 8 is a schematic view of the structure of the first layer plate and the third layer plate;

FIG. 9 is a schematic view of a first cutting surface and a first long side surface of the first strip;

FIG. 10 is a schematic view of the structure of the second layer plate;

FIG. 11 is a schematic view of a second cutting surface and a second long side surface of the second strip;

FIG. 12 is a schematic view of the length and width of the first strip and the second strip;

FIG. 13 is a schematic view of the third rounded corner and the fourth rounded corner of the side pressure plate.

In the drawings:

100, side pressure plate; 1000, first layer plate; 1001, square plate; 1002, cutting surface; 1003, long side surface; 1004, width dimension; 1005, length dimension; 2000, third layer plate; 2001, first rounded corner; 2002, third rounded corner; 3000, second layer plate; 3001, second rounded corner; 3002, fourth rounded corner; 4000, first strip; 4001, first cutting surface; 4002, first long side surface; 4003, first width dimension; 4004, first length dimension; 5000, second strip; 5001, second cutting surface; 5002, second long side surface; 5003, second width dimension; 5004, second length dimension.

### DESCRIPTION OF EMBODIMENTS

In describing the preferred embodiments, specific termi-nology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

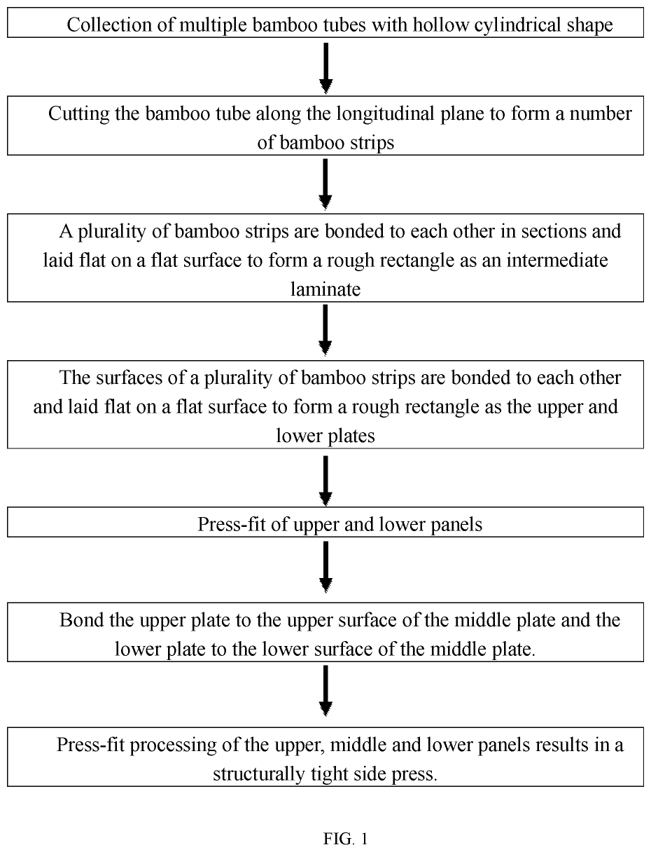

The present invention discloses a method of preparing a side pressure plate 100, as shown in FIG. 1, the method comprising collecting a plurality of bamboo tubes having a hollow cylindrical shape, cutting the bamboo tubes along a longitudinal plane to form a plurality of bamboo strips, bonding cross-sections of the plurality of bamboo strips to each other and laying them out flat on a flat plane to form a generally rectangular shape as an intermediate plate, bonding the surfaces of the plurality of bamboo strips to each other and laying them out flat on a flat plane to form a generally rectangular shape as an upper layer plate and a lower layer plate, and then press-fitting the upper layer plate and the lower layer plate to make them have a tighter structure, bonding the upper layer plate to the upper surface of the intermediate plate, bonding the lower layer plate to the lower surface of the intermediate plate, and press-fitting the upper, intermediate, and lower layers, ultimately forming the structurally tighter side pressure plate 100.

In this embodiment, the root and the tip of the bamboo are removed and the middle part is left, and it is cut into a number of hollow cylindrical bamboo tubes, and before bonding the cross sections of the bamboo strips to each other, the bamboo strips are carbonized and dried, and then polished to make a flat surface, so as to make the subsequent production process easier, and the upper layer plate and the lower layer plate are pressed side by side, so as to make the connection stronger and less likely to crack. The bamboo strips of the intermediate plate are placed horizontally in the direction of the bamboo strips of the upper layer plate and the lower layer plate, so as to make it have a more stable structure, and then the bonded bamboo plate is pressed and processed at the edges, so as to make it have a more solid structure, not easy to crack, and at the same time, make it have a more beautiful appearance, and it can effectively avoid the situation of the user's bumps and injuries in the use of the product.

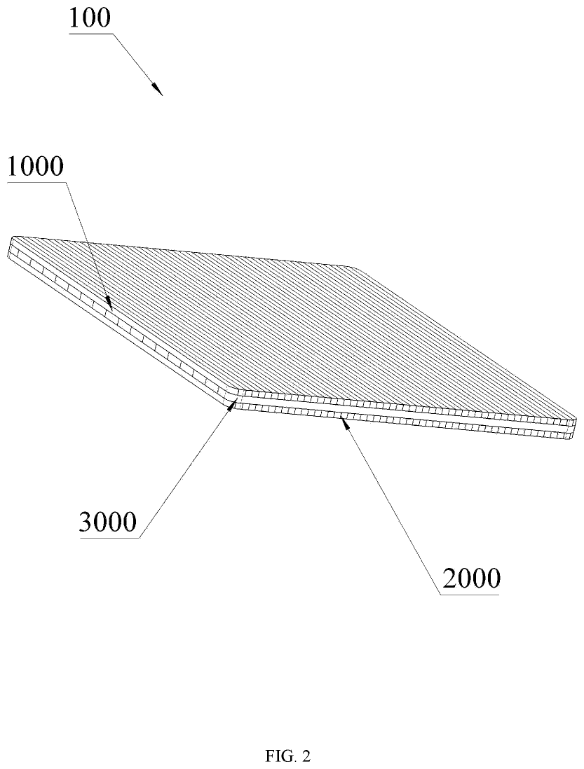

The present invention also discloses a side pressure plate 100, as shown in FIG. 2, comprising a first layer plate 1000 and a third layer plate 2000, and a second layer plate 3000 provided between the first layer plate 1000 and the third layer plate 2000.

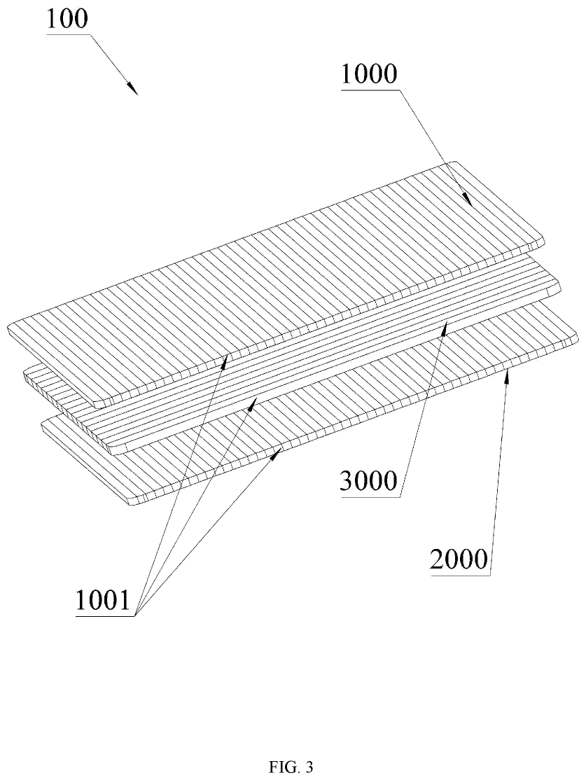

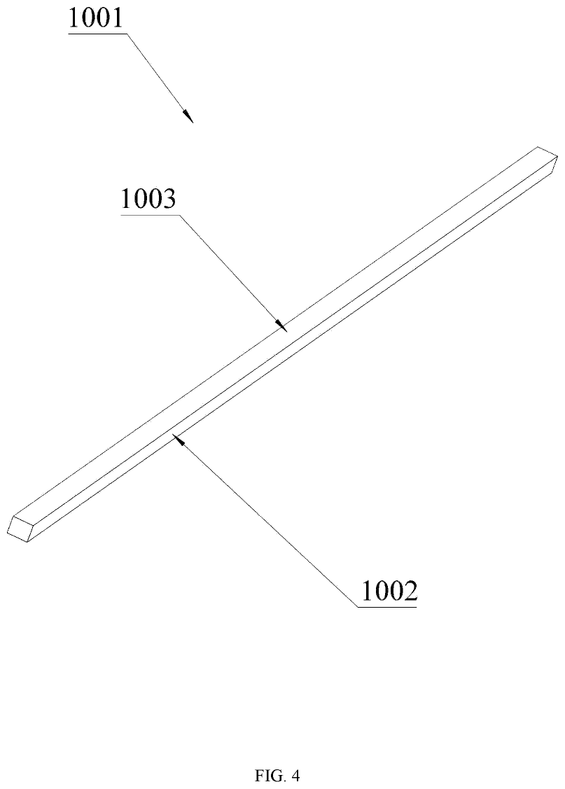

In this embodiment, as shown in FIG. 3, the first layer plate 1000, the second layer plate 3000, and the third layer plate 2000 all comprise a plurality of square plates 1001, wherein, as shown in FIG. 4, the square plates 1001 have two cutting surfaces 1002, and the cutting surfaces 1002 of the plurality of square plates 1001 are bonded to each other to form the second layer plate 3000, wherein the cutting surfaces 1002 have a rectangular structure, and the two cutting surfaces 1002 are provided opposite each other.

In this embodiment, the square plate 1001 further includes two long side surfaces 1003, and the long side surfaces 1003 of the plurality of square plates 1001 are bonded to each other to form the first layer plate 1000 and the third layer plate 2000, respectively, wherein the long side surfaces 1003 have a rectangular structure and the two long side surfaces 1003 are provided opposite to each other and are perpendicular to the cutting surfaces 1002.

In the wood processing production, the side pressure process is a common way of pressing the wooden strips, the wooden strips will be accurately placed in the position that needs to be pressed together, the pressure plate will be placed on the upper and lower sides of the wooden strips, to ensure that the pressure plate and the wooden strips are in close contact with each other and are smooth, in order to provide a uniform lateral pressure, or you can also use the clamps or bolts to fix the pressure plate to the wooden strips, through the clamps, bolts, or other tools to apply pressure, so that the pressure plate to the wooden strips to apply lateral pressure needs to be maintained for a fixed period of time for the pressure to be applied and for the dowel to cure sufficiently to ensure a good press fit. When the curing time is complete, the pressure is released and the clamps or bolts are removed to remove the platen from the dowel, thus completing the lateral press.

In this embodiment, the first layer plate 1000 and the third layer plate 2000 after bonding are respectively subjected to side pressure treatment, and the side pressure treatment can improve the strength of the connection between the plurality of square plates 1001 and increase the firmness of the connection, so that the first layer plate 1000 and the third layer plate 2000 are connected tightly and are not easy to crack.

In other embodiments (not shown in the figures), the second layer plate 3000 after the bonded connection is subjected to side pressing, which can give it a more stable structure.

In other embodiments (not shown in the figures), the plurality of square plates 1001 may be secured to each other by connectors, such as using nails to securely connect them to each other to form the first layer plate 1000, the second layer plate 3000, and the third layer plate 2000, wherein the length of the nails is greater than the width of the square plates 1001 to ensure that the nails can smoothly penetrate the two square plates 1001, the nails' insertion is carried out along the texture direction of the square plates 1001 to avoid a rupture of the square plates 1001, and the heads of the nails are flush with the surfaces of the square plates 1001 to make the first layer plate 1000, the second layer plate 3000, and the third layer plate 2000 more aesthetically pleasing.

In other embodiments (not shown in the figures), the plurality of square plates 1001 are connected to each other by screws, wherein, threaded holes are provided on the cutting surface 1002 of the square plate 1001, wherein the diameter of the threaded holes is slightly smaller than the diameter of the screws, and the screws are inserted in the other square plate 1001 adjacent thereto, and are screwed into the square plate 1001 with a screwdriver, thus fixing and connecting the plurality of square plates 1001 to form a second layer plate 3000, threaded holes are provided on the long side surface 1003 of the square plate 1001, wherein the diameter of the threaded holes is slightly smaller than the diameter of the screws, and the screws are inserted in another square plate 1001 adjacent thereto and screwed into the square plate 1001 with a screwdriver to securely connect the plurality of square plates 1001 to form the first layer plate 1000 and the third layer plate 2000, wherein the screws are screwed in a direction perpendicular to the grain direction of the square plate 1001 is perpendicular to the grain direction of the square plate 1001 to ensure the firmness of the connection, and the head of the screw is flush with the surface of the square plate 1001, so as to make the first layer plate 1000, the second layer plate 3000, and the third layer plate 2000 more aesthetically pleasing.

In other embodiments (not shown in the figures), the plurality of square plates 1001 may also be fixedly connected by mortise and tenon joints, wherein a tenon is provided on the cutting surface 1002 of the square plate 1001, a mortise is provided on the cutting surface 1002 of the square plate 1001 adjacent thereto, and the tenon and mortise joints connect the two square plates 1001 to each other, fixedly connecting the plurality of square plates 1001, thereby forming the second layer plate 3000, a tenon is provided on the long side surface 1003 of the square plate 1001, a mortise is provided on the long side surface 1003 of the square plate 1001 adjacent thereto, and the two square plates 1001 are connected together by the tenon and the mortise, thereby fixedly connecting the plurality of square plates 1001 to form the first layer plate 1000 and the third layer plate 2000, and through the tenon and the mortise, the plates have a high strength and are connected. The plates are made to have high strength and can withstand greater weight and pressure.

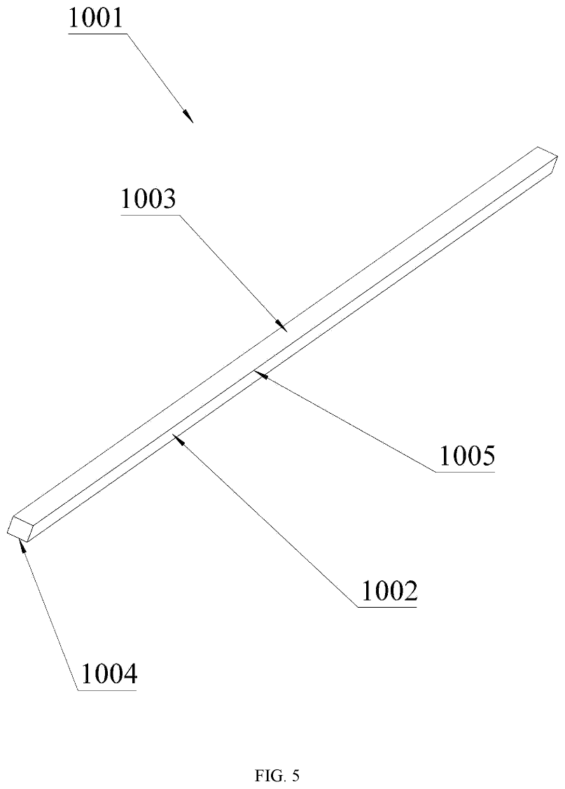

In this embodiment, as shown in FIG. 5, the square plate 1001 has a rectangular structure, wherein the square plate 1001 has a width dimension 1004 and a length dimension 1005, and the width dimension 1004 is divisible by the length dimension 1005, and in the subsequent production process, the first layer plate 1000 and the third layer plate 2000 are bonded with the second layer plate 3000 just to form the side pressure plate 100 of the desired size and dimension, and there is no need to carry out the subsequent cutting, which can effectively avoid the waste of the production material and make the subsequent production process easier, and has a flat side, making it more beautiful.

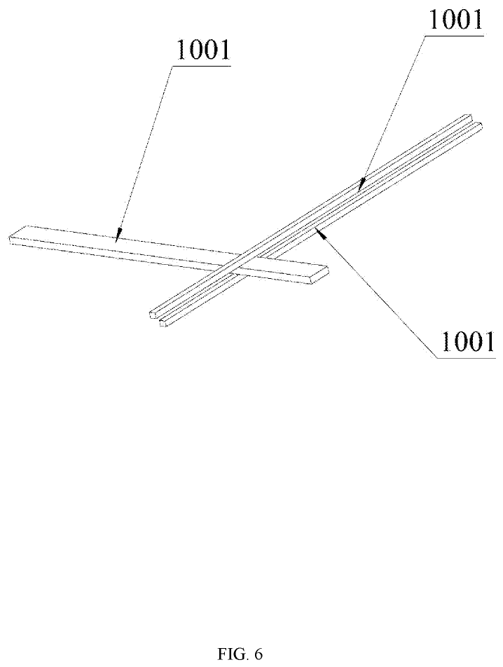

In this embodiment, as shown in FIG. 6, the direction of the square plate 1001 of the second layer plate 3000 is transverse to the direction of the square plate 1001 of the first layer plate 1000 and the second layer plate 3000, so that it has an “I” shaped side, and is capable of withstanding greater strength and pressure. In other embodiments (not shown in the figures), the orientation of the square plate 1001 of the second layer plate 3000 is the same as the orientation of the square plate 1001 of the first layer plate 1000 and the second layer plate 3000.

In this embodiment, the first layer plate 1000, the second layer plate 3000 and the third layer plate 2000 are made of bamboo material, which is not only green and environmentally friendly, but also has high strength and rigidity, and also has better abrasion resistance as well as antimicrobial properties as compared to other woods, and in addition, bamboo has a natural texture and color, which can make the wooden boards more aesthetically pleasing.

In other embodiments (not shown in the figures), the first layer plate 1000, the second layer plate 3000 and the third layer plate 2000 are made of wood. In other embodiments (not shown in the figures), the first layer plate 1000, the second layer plate 3000 and the third layer plate 2000 are made of plant fibers.

In this embodiment, the first layer plate 1000 and the second layer plate 3000 are bonded to each other by an adhesive, and the second layer plate 3000 and the third layer plate 2000 are bonded to each other by an adhesive.

In this embodiment, the adhesive is made of an organic polymer compound. In other embodiments (not shown in the figure), epoxy resin glue can be selected as the adhesive used in the production process of the present invention, epoxy resin glue has low toxicity, volatility is small, the proportion of wide, easy to operate, can be cured at room temperature, and the adhesive force is strong, toughness is good, and can effectively save the material and financial resources in the production process of the loss. In other embodiments (not shown in the figure), also can choose yellow aliphatic resin adhesive to be used as the invention in the production process of adhesives, yellow aliphatic resin adhesive has good thermal stability, as well as good weathering properties, and has good electrical insulation properties, in the high temperature outdoor conditions, can still maintain good adhesive properties.

In other embodiments (not shown in the figures), the first layer plate 1000, the second layer plate 3000, and the third layer plate 2000 may be secured to each other by connectors, such as using nails to securely connect the first layer plate 1000, the second layer plate 3000, and the third layer plate 2000 to each other, thereby forming the side pressure plate 100.

In other embodiments (not shown in the figures), the first layer plate 1000, the second layer plate 3000, and the third layer plate 2000 may also be connected by mortise and tenon joints, where a tenon is engraved on the lower surface of the first layer plate 1000, and a corresponding mortise is engraved on the lower surface of the second layer plate 3000, so as to snap the first layer plate 1000 and the second layer plate 3000 to each other; and a tenon is engraved on the lower surface of the second layer plate 3000, and a corresponding mortise is engraved on the upper surface of the third layer plate 2000, biting the second layer plate 3000 and the third layer plate 2000 into each other, thereby fixedly connecting the first layer plate 1000, the second layer plate 3000, and the third layer plate 2000 so as to form the side pressure plate 100.

In this embodiment, the side pressure plate 100 is pressed together so as to make the bonding more solid, have a more stable structure, be able to withstand greater strength, and be less likely to crack. In other embodiments (not shown in the drawings), the pressing of the side pressure plate 100 can be selected as a planar pressing method, and the planar pressing has the characteristics of being simple and convenient, efficient, stable and reliable as well as rigid, and has a wide scope of application, which can realize the reduction of cost and energy consumption in the production process. In other embodiments (not shown in the drawings), the pressing of the side pressure plate 100 may also be selected as a linear pressing method, whereby pressure in the horizontal direction is applied to the side pressure plate 100, thereby realizing the pressing, so as to make the adhesive bonding more solid and less susceptible to cracking.

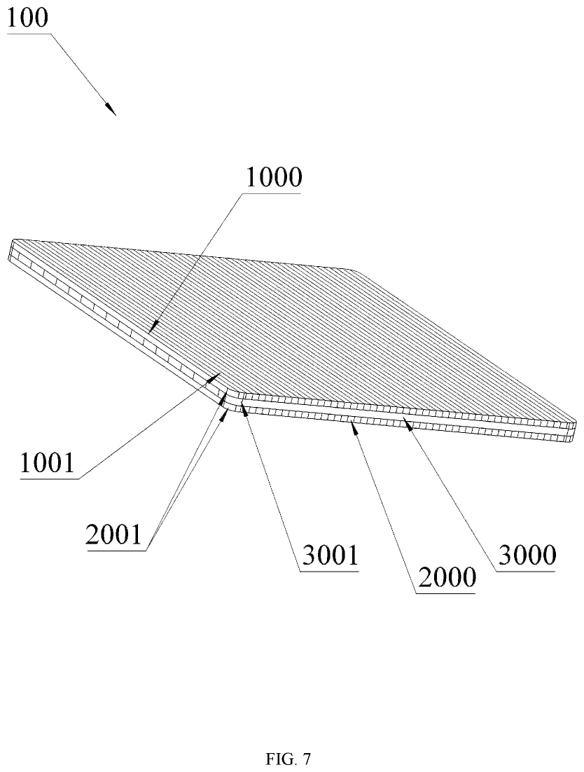

In this embodiment, as shown in FIG. 7, the first layer plate 1000 and the third layer plate 2000 are provided with first rounded corners 2001 along the prongs in the vertical direction, the radius of the first rounded corners 2001 being greater than the width of the square plate 1001, and the second layer plate 3000 is provided with second rounded corners 3001 along the prongs in the vertical direction, the radius of the second rounded corners 3001 being the same as the width of the square plate 1001, and the rounded corners are provided in such a manner as to effectively avoid the user from getting injured by collision in using the plate and to make the boards more aesthetic.

The present invention also discloses a side pressure plate 100 comprising a first layer plate 1000 and a third layer plate 2000, and a second layer plate 3000 provided between the first layer plate 1000 and the third layer plate 2000.

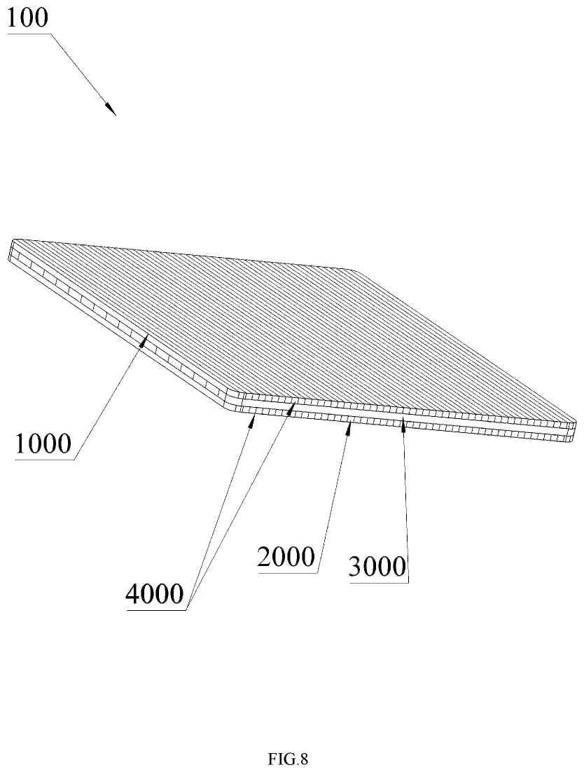

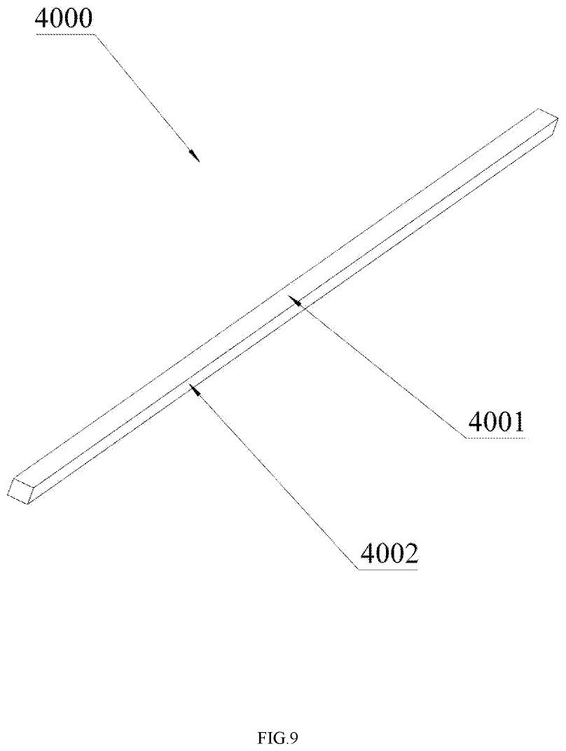

In this embodiment, as shown in FIG. 8, the first layer plate 1000 and the third layer plate 2000 both comprise a plurality of first strips 4000, and as shown in FIG. 9, the first strips 4000 have two first cutting surfaces 4001 and two first long sides 4002, and the first cutting surfaces 4001 of the plurality of first strips 4000 are bonded to each other to form the second layer plate 3000, wherein the first cutting surface 4001 is a cross-section formed after the hollow bamboo cylinder is truncated along the longitudinal direction, which has a rectangular structure, and the first long side 4002 has a rectangular structure, and the two first long side 4002 are provided opposite to each other and are relatively perpendicular to the first cutting surface 4001.

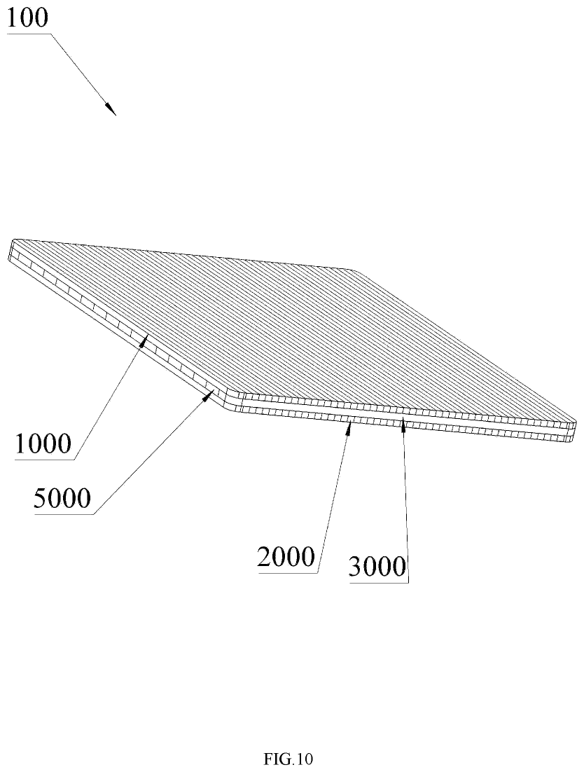

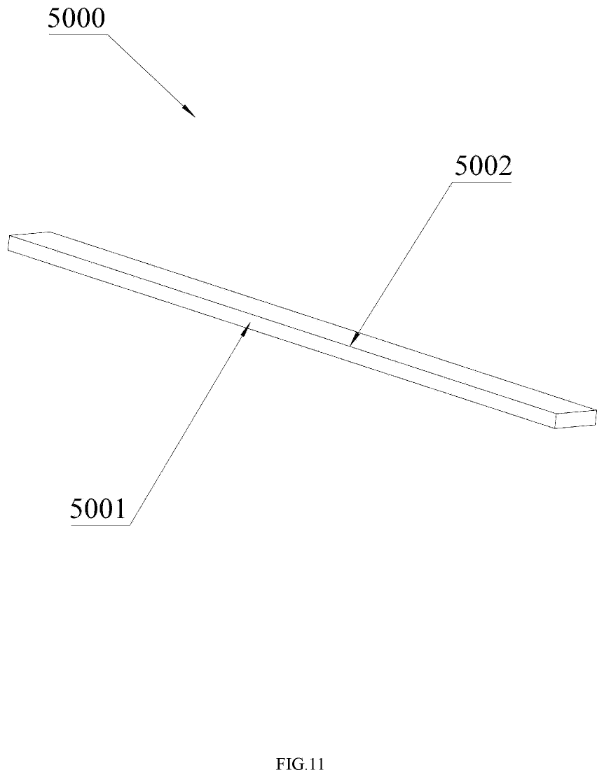

In this embodiment, the second layer plate 3000 as shown in FIG. 10 comprises a plurality of second strips 5000, and as shown in FIG. 11, the second strips 5000 have two second cutting surfaces 5001 and two second long side surfaces 5002, and the second long side surfaces 5002 of the plurality of second strips 5000 are bonded to each other to form the first layer plate 1000, and the third layer plate 2000, wherein the second cutting surface 5001 is a cross-section formed after the hollow bamboo cylinder is truncated along the longitudinal direction, which has a rectangular structure, and the second long side surface 5002 has a rectangular structure, and the two second long side surface 5002 are provided opposite to each other and are relatively perpendicular to the second cutting surface 5001.

In this embodiment, the thickness of the second strip 5000 is greater than the thickness of the first strip 4000. In other embodiments (not shown in the figures), the thickness of the second strip 5000 may be the same as the thickness of the first strip 4000.

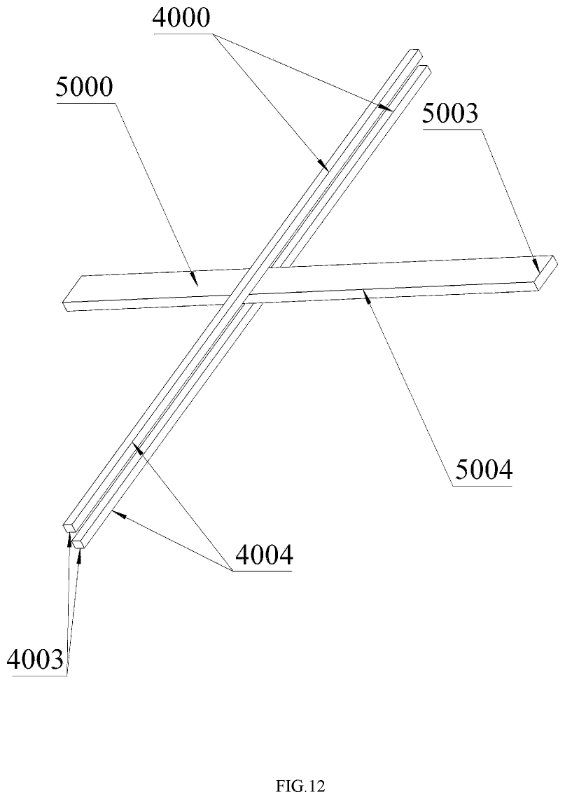

In this embodiment, the first strip 4000 and the second strip 5000 have a rectangular structure, as shown in FIG. 12, the first strip plate 4000 has a first width dimension 4003 and a first length dimension 4004, the first width dimension 4003 being divisible by the first length dimension 4004, and the second strip plate 5000 has a second width dimension 5003 and a second length dimension 5004, the second width dimension 5003 being divisible by the second length dimension 5004, and in the subsequent production process, the first layer plate 1000 and the third layer plate 2000 are bonded with the second layer plate 3000 just to form the side pressure plate 100 of the desired size and dimension, and there is no need to carry out the subsequent cutting, which can effectively avoid the waste of the production material and make the subsequent production process easier, and has a flat side, making it more beautiful.

In this embodiment, the first width dimension 4003 is larger than the second width dimension 5003, the first width dimension 4003 is divisible by the second length dimension 5004, and the second width dimension 5003 is divisible by the first length dimension 4004, and in the subsequent production process, the first layer plate 1000 and the third layer plate 2000 are bonded with the second layer plate 3000 just to form the side pressure plate 100 of the desired size and dimension, and there is no need to carry out the subsequent cutting, which can effectively avoid the waste of the production material and make the subsequent production process easier, and has a flat side, making it more beautiful.

In this embodiment, the direction of the second strip 5000 is transverse to the direction of the first strip 4000. In other embodiments (not shown in the figures), the second strip 5000 may be oriented in the same direction as the first strip 4000.

In this embodiment, the first layer plate 1000, the second layer plate 3000 and the third layer plate 2000 are made of a bamboo material. In this embodiment, the first layer plate 1000 and the second layer plate 3000 are bonded by an adhesive, and the second layer plate 3000 and the third layer plate 2000 are bonded to each other by an adhesive. Wherein the adhesive is made of an organic polymer compound.

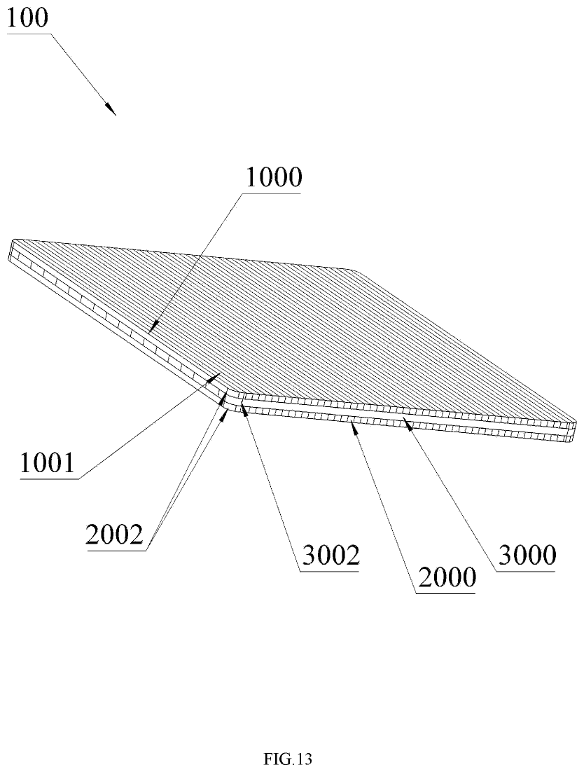

In this embodiment, as shown in FIG. 13, the first layer plate 1000 and the third layer plate 2000 are provided with a third rounded corner 2002 along the prongs in the vertical direction, the radius of the third rounded corner 2002 being greater than the width of the first strip 4000, and the second layer plate 3000 is provided with a fourth rounded corner 3002 along the prongs in the vertical direction, the radius of the fourth rounded corner 3002 being the same as the width of the second strip 5000, which through the provision of the rounded corners, can effectively avoid the user from getting injured by a collision when using the plate, and can make the wooden boards more aesthetically pleasing.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

What is claimed is:

1. A method of preparing a side pressure plate, the method comprising:
a plurality of bamboo tubes with a hollow cylindrical shape were collected; and
a plurality of bamboo strips are formed by truncating said bamboo tube along a longitudinal plane; and
a plurality of said bamboo strips are bonded together in cross section and laid flat on a flat plane to form an approximately rectangular shape as an intermediate plate; and
the surfaces of a plurality of said bamboo strips are bonded to each other and laid flat on a flat plane to form a roughly rectangular shape as upper layer plate and lower layer plate; and
press-fit said upper layer plate and said lower layer plate; and
bonding said upper layer plate to the upper surface of said intermediate plate and bonding said lower layer plate to the lower surface of said intermediate plate; and
said upper layer plate, said intermediate plate and said lower layer plate are pressed together to finally form the side pressure plate with a compact structure.

2. A method of preparing a side pressure plate according to claim 1, wherein before bonding a cross-section of a plurality of said bamboo strips to each other, a plurality of said bamboo strips are carbonized and dried, and a plurality of said bamboo strips are planed and sanded after carbonization and drying so as to have a flat surface.

3. A method of preparing a side pressure plate according to claim 2, wherein the press-fit treatment of said upper layer plate and said lower layer plate is by side pressing.

4. A method of preparing a side pressure plate according to claim 1, wherein the direction of placement of said bamboo strips of said intermediate plate is transverse to the direction of placement of said bamboo strips of said upper layer plate and said lower layer plate.

5. A method of preparing a side pressure plate according to claim 1, wherein said upper layer plate, said intermediate plate, and said lower layer plate after multi-compacting treatment are edge-treated.

6. A side pressure plate comprising:
a first layer plate and a third layer plate, and a second layer plate provided between said first layer plate and said third layer plate; and
wherein said first layer plate, said second layer plate and said third layer plate all comprise a plurality of square plates; and
said square plates has at least one cutting surface, and said cutting surface of a plurality of said square plates are bonded to each other to form said second layer plate; and
said square plates further comprises at least one long side surface, and said long side surface of a plurality of said square plates are bonded to each other to form said first layer plate and said third layer plate.

7. A side pressure plate according to claim 6, wherein said square plate has a rectangular structure.

8. A side pressure plate according to claim 7, wherein said square plate has a width dimension and a length dimension, said width dimension being divisible by said length dimension.

9. A side pressure plate according to claim 8, wherein the direction of said square plate of said second layer plate is transverse to the direction of said square plate of said first layer plate and said third layer plate.

10. A side pressure plate according to claim 9, wherein said first layer plate, said second layer plate and said third layer plate are made of bamboo material.

11. A side pressure plate according to claim 6, wherein a plurality of said square plates are bonded to each other by adhesive, said adhesive being made of an organic polymer compound.

12. A side pressure plate comprising:
a first layer plate and a third layer plate, and a second layer plate provided between said first layer plate and said third layer plate; and
wherein said second layer plate comprises a plurality of first strips, said first strips having at least one first cutting surface and at least one first long side surface, said first cutting surface of said plurality of said first strips being bonded to each other to form said second layer plate; and
said first layer plate and said third layer plate both comprise a plurality of second strips, said second strips having at least one second cutting surface and at least one second long side surface, said second long side surfaces of said plurality of said second strips being bonded to each other to form said first layer plate and said third layer plate.

13. A side pressure plate according to claim 12, wherein the thickness of said first strips is greater than the thickness of said second strips.

14. A side pressure plate according to claim 13, wherein said first strips and said second strips both have a rectangular structure.

15. A side pressure plate according to claim 14, wherein said first strip has a first width dimension and a first length dimension, said first width dimension being divisible by said first length dimension.

16. A side pressure plate according to claim 15, wherein said second strip has a second width dimension and a second length dimension, said second width dimension being divisible by said second length dimension.

17. A side pressure plate according to claim 15, wherein said first width dimension is greater than said second width dimension, said first width dimension is divisible by said second length dimension, and said second width dimension is divisible by said first length dimension.

18. A side pressure plate according to claim 13, wherein the direction of said first strip is transverse to the direction of said second strip.

19. A side pressure plate according to claim 13, wherein said first layer plate, said second layer plate and said third layer plate are made of bamboo material.

20. A side pressure plate according to claim 13, wherein the plurality of said first strips and the plurality of said second strips are bonded to each other by an adhesive, said adhesive being made of an organic polymer compound.
